(19) United States
(12) Patent Application Publication
(10) Pub. No.: US 2003/0220925 A1
(43) Pub. Date: Nov. 27, 2003

(54) System and method for web services management

(76) Inventor: Avi Lior, Nepean (CA)

Correspondence Address: HAYES SOLOWAY PC, 130 W. Cushing Street, Tucson, AZ, 85701, US

(21) Appl. No.: 10/355,537

(22) Filed: Jan. 31, 2003

(30) Foreign Application Priority Data
Jan. 31, 2002 (CA) 2,369,797

(51) Int. Cl. G06F 7/00

(52) U.S. Cl. 707/10

(57) ABSTRACT

A method of provisioning Web services is provided. The method comprises the steps of receiving a Web services description language document of a Web service, automatically extracting information associated with the Web service, and automatically generate a record of the information for use in access policies of the Web service.

### FIELD OF THE INVENTION

The invention relates to software and Web services. In particular, the invention relates to a system and method of automatic discovery and provisioning of Web services.

### BACKGROUND OF THE INVENTION

Web services are a protocol that provides two or more applications the means to communicate for the purpose of exchanging information. The messages that are exchanged conform to the simple object access protocol (SOAP) specification. The SOAP specification describes the structure of the message but not its contents. As well, the SOAP specification allows for different styles of communication, document exchange or remote procedure call. Finally, the SOAP specification defines how SOAP messages should be bound to various transports such as hypertext transfer protocol (HTTP) or simple mail transfer protocol (SMTP).

In this specification, consumers (or consumer applications) are other applications that consume (or invoke) the Web services produced by producers or developers (or providers) of Web services. To consume a Web service, the consumer application must know how to formulate their SOAP message that is, what style is expected, what the contents of the message should be, what transport to use and how to bind the message and its contents of the transport.

One way in which the producers of Web services describe their Web services to the consumer is by publishing a document written in accordance to the Web Services Description Language (WSDL). A WSDL document is used to describe the operations, parameters and the transport binding for a Web service. That is, this document provides the details used to invoke a Web service including, whether the Web service is document based or remote procedure call based, the expected content of the various messages that are to be exchanged, and how these are to be bound to the various transports that are supported by the producers of the Web services. The WSDL document is made available to consumers of the Web service by either placing the document in a file system at a known location, by publishing the document in a Universal Discovery and Description Integration (UDDI) directory, or by any other means one can communicate any document.

To control access to the Web services that are published, producers may deploy access management systems designed to control access to the Web services. These systems determine which consumer may be granted access to which Web service, or operation (or method) of a Web service, by examining the messages being transacted and evaluating them against an access policy. The access management systems must therefore have prior knowledge of the messages, their structure, and transport mechanism. This knowledge is often gained during the configuration of the policies by requiring the administrator to manually enter the required information. As well, as new Web services are made available, or as Web services are decommissioned or altered, the administrator must manually reflect those changes to maintain the efficacy of the access management system.

FIG. 1 shows an example of a typical Web services system 10. The Web services system 10 comprises an application 11, a WSDL document repository 12, a Web service 13, an access control point 14, and an access control policy file 15. The Web service 13 may publish a WSDL document into the WSDL document repository 12. The application 11 may read a WSDL document from the WSDL document repository 12 for a service that the user of the application 11 wishes to consume. The application 11 may formulate a SOAP message to consume the service based on the information obtained in the WSDL document. The application 11 sends the SOAP call to the Web service 13 address specified in the WSDL document. This SOAP call is intercepted by the access control point 14. The access control point 14 detects the SOAP message and based on the content of the message matches the message with its various policies and determines whether to allow access or not. If all policies agree (authentication, authorization and other policies), the access control point 14 allows the SOAP request to pass to the Web service 13. The Web service 13 may generate and send a response to the application 11. The access control point 14 detects the SOAP message response and based on the content of the message matches the message with its various policies and determines whether to allow the message to be sent back to the application 11. If all policies agree (accounting, auditing, and other policies) the SOAP message is allowed to proceed to the application 11.

The existing methodologies require extensive manual interaction and monitoring which consumes valuable human resources. The manual interaction is tedious and prone to errors.

### SUMMARY OF THE INVENTION

It is an object of the present invention to provide a novel method for automatically provisioning Web services access management systems, and maintaining those policies as the Web services change, to maintain overall efficacy while reducing the workload of the administrator.

One aspect of the invention is to have the access management system extract the required information from the WSDL documents regardless of where that document is stored.

Another aspect of the invention is to maintain the provisioned information by the periodic processing of the WSDL document.

In one aspect of the present invention, there is provided a method of provisioning Web services. The method comprises the steps of receiving a Web services description language document of a Web service, automatically extracting information associated with the Web service, and automatically generate a record of the information for use in access policies of the Web service.

In another aspect of the present invention, there is provided a method for updating a Web services provisioning information file. The method comprises the steps of receiving notice of a change to a Web service, automatically obtaining a Web services description language document of the Web service, automatically extracting changed information of the Web services description language document, and automatically updating a recorded entry of the Web service in the Web services provisioning information file.

In another aspect of the present invention, there is provided a system for provisioning Web services. The system comprises a Web services information file used for generating access policies for the Web services, and an access control provisioning module for automatically generating and updating the Web services information file.

### BRIEF DESCRIPTION OF THE DRAWINGS

FIG. 1 shows an example of a typical Web services system.

FIG. 2 shows an example of a Web services provisioning system, in accordance with an embodiment of the present invention.

FIG. 3 shows an example of an access control provisioning module, in accordance with an embodiment of the Web services provisioning system.

FIG. 4 is a flowchart showing a method of provisioning Web services, in accordance with an embodiment of the Web services provisioning system.

FIG. 5 is a flowchart showing a method of updating a Web services information file, in accordance with an embodiment of the Web services provisioning system.

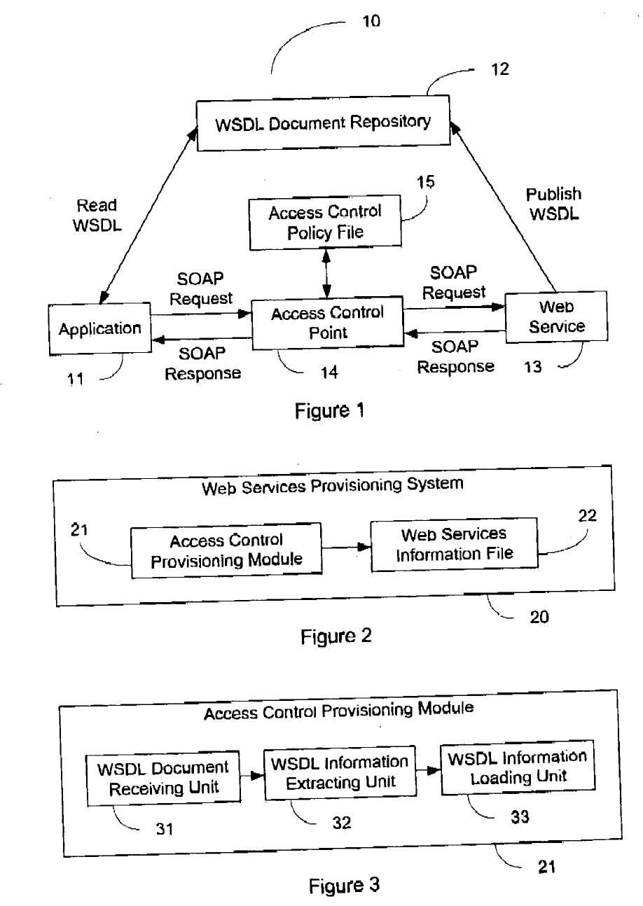

### DETAILED DESCRIPTION OF THE EMBODIMENTS

This document provides an exemplary description of the invention in the context of a Web service description language (WSDL) document and the simple object access protocol (SOAP). It is understood that the invention applies to other documents which provide information of Web services as discussed below. It is also understood that the invention applies to other Web service communication protocols other than SOAP.

FIG. 2 shows an example of a Web services provisioning system 20, in accordance with an embodiment of the present invention. The Web services provisioning system 20 comprises an access control provisioning module 21 and a Web services information file 22. The Web services information file 22 is a record of information pertaining to Web services. The Web services information file 22 may be similar to the access control policy file 15. The access control provisioning module 21 is used for generating and updating the Web services information file 22.

There are different styles of Web services, including a remote procedure call style and a document style. Typically, one function of the provisioning function of a Web service access management system is to identify information about a Web service. In the case of the remote procedure call style, the Web service information includes:

the name of the methods or operations available in the Web service;

the parameters in a request message used by an application to call the methods;

the parameters in a response message sent by the Web service to the requesting application;

the fault message (if any) that will be returned to the consumer of the Web service when errors occur;

the value of a SOAP action parameter (The SOAP action is required to be present in SOAP 1.1 and can be used to provide security or routing. The SOAP action may be modified or removed in later release of SOAP.);

the existence of pertinent SOAP headers and their formats (SOAP headers contain meta information about a SOAP call, including security assertions such as Security Assertion Markup Language (SAML). A SOAP header containing SAML security assertions is typically used to cryptographically sign an/or encrypt part or all of a SOAP message. Other examples of SOAP headers include transactional contexts, and other application specific information.); and

the location or address used to access the Web service.

In the case of the document style, the Web service information includes:

the contents of the request document;

the contents of the response document, the contents of the fault document;

the existence of pertinent headers and their contents;

the format of the fault response;

the location or address used to access the Web service; and

the protocol used to access the Web service.

Other information which may be obtained from a WDSL document includes the type of security which is needed to access the Web service or its method calls. For example, is a certificate are required? Is it a requirement to use an encrypted pipe or channel? Is security required at all?

All or some of this information can be used to formulate access policies, formulate policies for validating the messages and documents, detect the presence of faults, and generate policies that generate audit and tracking records. The manual entry of the required information into an access control policy file 15 can be time consuming and prone to errors. Often new Web services are commissioned and some Web services are decommissioned. It is desirable that such changes are reflected in the access management system accurately and in a timely basis.

For each Web service in the Web services information file 22, there is a record of the above information. For example, the record may be a data base entry with fields associated with the type of information described above.

FIG. 3 shows an example of an access control provisioning module 21, in accordance with an embodiment of the Web services provisioning system 20. The access control provisioning module 21 comprises a WSDL document receiving unit 31, a WSDL information extracting unit 32, and a WSDL information loading unit 33. The WSDL document receiving unit 31 receives and reads WSDL documents of Web services which are published in a WSDL document repository such as a file system or a Universal Discovery and Description Integration (UDDI) directory. The WSDL document receiving unit 31 may be given a universal resource locator (URL) of a WSDL document from a developer or administrator of the Web service. Alternatively, the WSDL document receiving unit 31 may search a specific address or location on a file system or storage medium, and/or query a UDDI directory for WSDL documents.

By having the WSDL document receiving unit 31 import the WSDL document that is published for each Web service, it is possible to extract the information used to provision Web service policies described above, and provide for accurate and timely Access Controls. Advantageously, computer processing instead of manually processing decreases the time required to input and avoids human errors caused by manual entry of Web service information. The WSDL document receiving unit 31 sends the WSDL document to the WSDL information extracting unit 32 to extract the relevant Web service information described above. For example, from a WSDL document for a weather Web service which provides an application 11 with the weather in an area on a date, some of the information the WSDL information extracting unit 32 could extract includes:

the URL used by an application 11 to access the temperature Web service;

the method call(s) used by the temperature Web service,

e.g., getTemperature( );

parameters used in the method call(s).

e.g., Zip Code, Date in getTemperature(Zip Code, Date); and

the type of expected result

e.g., integer or float representing a temperature in degrees Celsius or Fahrenheit).

Since WSDL documents are typically generated in extensible markup language (XML), the Web service information may be extracted using an XML parser.

The WSDL information extraction unit 21 uses an XML parser to build an internal representation of the WSDL file. The internal representation is an in memory tree structure that can be navigated by other modules such as the WSDL information loading unit 33. The tree structure allows these modules to locate the various tags of the WSDL file and extract the information that is needed. Some of the major tags are the <service . . . > tag that defines the Web Service, the <portType . . . > tag that defines the abstracted web service, and the <binding . . . > tag that define how the abstracted web service is bound to a specific transport layer such as HTTP or SMTP.

Once the information is extracted, the information is passed to the WSDL information loading unit 33 to be loaded into the Web service information file 22. The WSDL information loading unit 33 may generate a database file, or add an entry into an existing database file. The entries of the database file include fields for the above extracted information. The entries of the database file include a fields for assigning zero or more categories to the Web service and each Web service method call. The categories may be initially set to a default ‘public’ category, other category, or left empty.

The units 31, 32, 33 of the access control provisioning module 21 may comprise code for performing the respective functionality. Alternatively, the access control provisioning module 21 may comprise code which performs all the functions of the WSDL document receiving unit 31, WSDL information extracting unit 32, and WSDL information loading unit 33.

Once an inventory of Web services has been generated and stored in the Web services information file 22, an administrator may modify the categories as desired. The Web services information file 22 may be used by a Web services system 10 as an access control policy file.

Access controls may be applied by assigning categories to a Web service, to a Web service method, or a Web service with a particular parameter set to a value. Consumers of Web services may also be assigned a set of categories. A consumer can access a Web service if one of the consumer categories matches on of the categories assigned to the Web service or Web service method that the consumer is accessing. Consumers are assigned the ‘public’ category by default. As a matter of policy, Web services can be automatically assigned the public category or not assigned any category, by default.

For example, the weather Web service maybe assigned a ‘public’ category and a method within the weather Web service, such as getTemperature( ), will therefore inherit the public category. Another method within the weather Web service, such as getBarometricPressure( ) may be assigned a category the ‘gold’ category. This assignement will override the ‘public’ category assigned to the temperature weather service in general. Furthermore, a ‘gold’ category can be assigned to a getHistoricalTemperatures( ) method if the value of the Zip Code parameter is not equal to the Zip Code associated with the consumer of the Web service. Therefore, with the above assignment consumers will be able to access the methods of the weather Web service except for getBarometricPressure( ) and getHistoricalTemperatures( ). However, the access is limited for their location only (since their Zip Code must match the Zip Code entered for the Web service). Consumers that are assigned the gold category will be allowed to access all the methods, including getBarometricPressure( ) and getHistoricalTemperatures( ) for any Zip Code.

The access provisioning module 21 may also be used to update the Web services information file 22 to reflect changes to a WSDL document, or to add new Web service entries to the Web services information file 22. The access provisioning module 21 may further include a WSDL document monitoring unit (not shown) which monitors addresses or UDDI servers having WSDL documents for new WSDL documents and/or for changes to existing WSDL documents. The act of publishing a WSDL document or updated WSDL document may send a signal to the WSDL document monitoring unit.

The WSDL document monitoring unit, on a periodically configurable interval, may check the WSDL documents that the unit has been assigned to manage. If the WSDL file is located in a file system, the WSDL document monitoring unit may periodically check the presence of the file and check the last modification date of the file. If the WSDL document exists within a UDDI directory, the WSDL document monitoring unit may either check the last modified date (if available) or failing that, fetch the document and compute a checksum which is compared to a previous checksum. If a document is missing, the WSDL document monitoring unit may flag an error to the administrator and optionally lock access to the Web services associated with that WSDL document. The WSDL document monitoring unit may also periodically monitor specific locations such as a file system directory, a UDDI directory, and a file transfer protocol (FTP) site. If a new WSDL document is placed in such a location, the WSDL document monitoring unit can process that WSDL document and continue to monitor it for changes. The WSDL document monitor unit may also receive a signal from an application programming interface (API) or via the configuration user interface to execute a check on a specific file, or on all the files in a given location, or all locations.

By having the access control provisioning module 21 periodically monitor any changes to the WSDL document files, alerts may be generated when human intervention will be required, for example, when changes in the Web services require changes in the access policies or fault detection policies. Furthermore, by monitoring the well known locations where WSDL documents are published, such as a directory in a file system or UDDI registry, the access control provisioning module 21 can detect the presence of new Web services. The corresponding new WSDL documents may be imported and processed as described above. If the WSDL document is an update, then inherited privileges may be automatically assigned, as described above. The access control provisioning module 21 may also alert the administrator that a new Web service has beet detected and allow the administrator to set up policies as required.

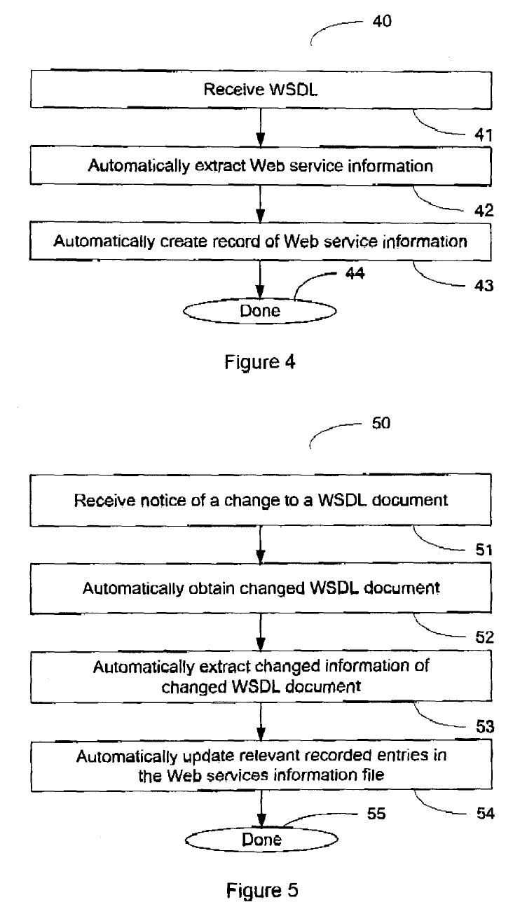

FIG. 4 is a flowchart showing a method of provisioning Web services (40), in accordance with an embodiment of the Web services provisioning system 20. The method (40) begins with receiving a WSDL document of a Web service (41). A WSDL document receiving unit 31 may receive a location of a WSDL document directly from a Web service developer. The WSDL document receiving unit 31 may locate and obtain the WSDL document from a specific address in a network or location in a file system, or by querying a UDDI server.

Once the WSDL document has been obtained (41), information associated with the Web service is automatically extracted (42). The WSDL information extracting unit 32 may parse the WSDL document to extract information such as a URL to access the Web service, one or more methods of the Web service, one or more parameters used to call the methods of the Web service, one or more result types associated with a response to the called methods, and the transport protocol to be used to access the Web service. The URL may be extracted by parsing the <service> tags and <binding> tags contained within the WSDL document. A method name may be extracted by parsing the <binding> tags and associated <portType> tags in the WSDL document. The parameters may be extracted from each Web service method in the WSDL document. The result types may be extracted by parsing the result types and their respective parameters from each Web service method in the WSDL document. The transport protocol may be extracted by parsing the WSDL document and examining the various binding definitions for the Web service. The binding definitions contained in the WSDL document will define the type of transport(s) that are available for the Web service. Examples are HTTP get or post, SMTP.

Once the relevant information has been extracted (42), a record of the information for use in policies of the Web service is automatically generated (43). The record may be generated by adding an entry into a database record of Web service provisioning information. The fields of the database record entry may be populated with the information extracted from the WSDL document in step (42). The database record may be initially generated by the WSDL information loading unit 32. Records in the database may have a category field which may be set to default ‘public’ category by the WSDL information loading unit 32. Examples of default settings include no access or public access to the Web service and its methods.

Once the record of information is generated (43), the method is done (44). The method (44) may further include steps of monitoring WSDL document repositories 12 for changes to WSDL documents and updating the respective database records accordingly. When generating an initial Web services information file 22, steps 41 to 43 may be repeated for each WSDL document in a WSDL document repository 12.

FIG. 5 is a flowchart showing a method of updating a Web services information file 22 (50), in accordance with an embodiment of the Web services provisioning system 20. The method (50) begins with receiving notice of a change to a WSDL document of a Web service (51). The notice may come from a developer of the Web service. Alternatively, the WSDL document monitoring unit may periodically monitor for WSDL document changes in network addresses or UDDI servers having WSDL documents, as described above.

Once a change to a WSDL document has been detected or received (51), the WSDL document receiving unit 31 automatically obtains the changed WSDL document (52) in the same manner as described above. The WSDL information extracting unit 32 automatically extracts the changed information of the changed WSDL document (53) in the same manner as described above. The WSDL information loading unit 33 automatically updates the relevant recorded entry in the Web service information file 22 (54). Once the Web service information file 22 is updated (54), the method is done (55).

Other steps may be added to this method (50), such as alerting an administrator that a change has occurred, and periodically monitoring network addresses and UDDI registries for changes to WSDL documents. The addition of a periodic monitoring step may convert the method (50) into a loop. The method (50) or its modified loop method may be appended to method (40) to form a method of automatically generating and automatically updating a Web services information file 22.

While particular embodiments of the present invention have been shown and described, it is clear that changes and modifications may be made to such embodiments without departing from the true scope and spirit of the invention.

The method steps of the invention may be embodiment in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may store code to execute such method steps. As well, electronic signals representing these method steps may also be transmitted via a communication network.

While exemplary embodiments described herein focus on particular software applications, it would be clear to one skilled in the art that the invention may be applied to other computer or control systems. The protected software of the invention can be stored on any suitable storage device and executed on any manner of computing device. It is just as mobile as any other software application, and can be downloaded to users over the Internet or via email, transferred from a personal computer (PC) to a laptop, or stored on a CD ROM or hard disk drive. Accordingly, the invention could be applied to:

1. Computers such as personal computers, personal digital assistants, laptop computers and other similar devices;

2. Network and system components such as servers, routers, gateways and other similar devices; and

3. All manner of appliances having computer or processor control including telephones, cellular telephones, televisions, television set top units, point of sale computers, automatic banking machines and automobiles.

What is claimed is:

1. A method of provisioning Web services, the method comprising the steps of:
receiving a Web services description language document of a Web service;
automatically extracting information associated with the Web service; and
automatically generate a record of the information for use in access policies of the Web service.

2. The method as claimed in claim 1, wherein the step of receiving comprises the steps of:
locating the Web services description language document; and
obtaining the Web services description language document.

3. The method as claimed in claim 2, wherein the step of locating comprises the step of searching a specific address in a network or location in a file system.

4. The method as claimed in claim 1, wherein the step of receiving comprises the step of querying a universal discovery and description integration server.

5. The method as claimed in claim 1, wherein the step of extracting comprises the steps of:
extracting a universal resource locator used to access the Web service;
extracting a method of the Web service;
extracting one or more parameters used to call the method;
extracting one or more result types associated with a response to the method; and
extracting a transport protocol used to access the Web service.

6. The method as claimed in claim 5, wherein a plurality of Web service methods are extracted from the Web service.

7. The method as claimed in claim 5, wherein the step of extracting a universal resource locator comprises the step of parsing a <service> tag and a <binding> tag from the Web services description language document.

8. The method as claimed in claim 5, wherein the step of extracting a method of the Web service comprises the step of parsing a <binding> tag and an associated <portType> tag from the Web services description language document.

9. The method as claimed in claim 5, wherein the step of extracting one or more parameters comprises the step of parsing the Web services description language document for the one or more parameters.

10. The method as claimed in claim 5, wherein the step of extracting one or more result types comprises the step of parsing the Web services description language document for the result type and for parameters of the result type.

11. The method as claimed in claim 5, wherein the step of extracting a transport protocol comprises the steps of:
parsing the Web services description language document; and
examining binding definitions for the Web service.

12. The method as claimed in claim 1, wherein the step of generating comprises the step of adding an entry into a data base record of Web service provisioning information, wherein the fields of the data base record entry are populated with the information extracted from the Web services description language document.

13. The method as claimed in claim 12, further comprising the step of generating a data base record of Web services provisioning information.

14. The method as claimed in claim 12, further comprising the step of setting an access field in the data base record entry to a default setting.

15. The method as claimed in claim 1, further comprising the steps of:
monitoring the Web services description language document for changes; and
updating the record of information with the changes.

16. A method for updating a Web services provisioning information file, the method comprising the steps of:
receiving notice of a change to a Web service;
automatically obtaining a Web services description language document of the Web service;
automatically extracting changed information of the Web services description language document; and
automatically updating a recorded entry of the Web service in the Web services provisioning information file.

17. The method as claimed in claim 16, wherein the step of receiving comprises the step of receiving the notice from a Web service developer.

18. The method as claimed in claim 16, wherein the step of receiving comprises the step of periodically monitoring a location of the Web services description language document.

19. The method as claimed in claim 18, further comprising the step of checking the last modification date of the Web services description language document.

20. The method as claimed in claim 18, further comprising the steps of:
obtaining the Web services description language document;
computing a checksum; and
comparing the checksum with a previous checksum.

21. The method as claimed in claim 16, wherein the step of obtaining comprises the step of querying a universal discovery and description integration server.

22. The method as claimed in claim 16, wherein the step of obtaining comprises the step of downloading the Web services description language document.

23. The method as claimed in claim 16, wherein the step of extracting comprises the steps of:
determining if one or more of
a universal resource locator used to access the Web service;
a method of the Web service;
one or more parameters used to call the method; and
one or more result types associated with a response to the method; has changed; and
extracting the changed information.

24. The method as claimed in claim 16, wherein the step of updating comprises the step of adding an entry into a data base record of Web service provisioning information, wherein the fields of the data base record entry is populated with the information extracted from the Web services description language document.

25. The method as claimed in claim 16, wherein the step of updating comprises the step of updating fields in the recorded entry associated with the changed information.

26. A system for provisioning Web services, the system comprising:
a Web services information file used for generating access policies for the Web services; and
an access control provisioning module for automatically generating and updating the Web services information file.

27. The system as claimed in claim 26, wherein the Web services information file is a data base file comprising fields comprising information relating to the Web services.

28. The system as claimed in claim 26, wherein the Web services information file comprises an access field.

29. The system as claimed in claim 26, wherein the access control provisioning module comprises:
a Web services description language document receiving unit for receiving a Web services description language document of a Web service;
a Web services description language information extracting unit for extracting information associated with the Web service; and
a Web services description language information loading unit for generating a record of the information in the Web services information file for use in access policies of the Web service.

30. The system as claimed in claim 29, further comprising a Web services description language document monitoring unit for receiving notice of a change to a Web services description language document.

31. The system as claimed in claim 30, wherein the Web services description language document monitoring unit further comprises means for monitoring the Web services description language document for changes.

32. The system as claimed in claim 30, wherein the Web services description language information extracting unit further comprises means for extracting the changed information associated with the Web service.

33. The system as claimed in claim 30, wherein the Web services description language information loading unit further comprises means for updating the record of the information with the changed information.
